(19) United States
(12) Patent Application Publication
(10) Pub. No.: US 2025/0016247 A1
(43) Pub. Date: Jan. 9, 2025

(54) DEVICE AND METHOD FOR JOINT LOCAL AND REMOTE INFERENCE

(71) Applicant: HUAWEI TECHNOLOGIES CO., LTD., Shenzhen (CN)

(72) Inventors: Theodoros Giannakas, Munich (DE); Dimitrios Tsilimantos, Boulogne Billancourt (FR); Apostolos Destounis, Munich (DE)

(21) Appl. No.: 18/893,780

(22) Filed: Sep. 23, 2024

Related U.S. Application Data
(63) Continuation of application No. PCT/EP2022/057740, filed on Mar. 24, 2022.

(51) Int. Cl. H04L 67/59; G06N 3/098; H04L 67/00

(52) U.S. Cl. CPC H04L 67/59; G06N 3/098; H04L 67/34

(57) ABSTRACT

A device (400, 703) for processing a data sample (401, 701) to form a predicted output (409, 410) configured to: receive (801) the data sample (401, 701); input (802) the data sample (401, 701) and/or one or more of any intermediate outputs (406) derived from the data sample to a learnable control function (402); and in dependence on an output (403) of the function (402), perform (803) one of the following: (i) process the data sample (401, 701) to form the predicted output (409) using a first model (404, 405, 704) stored locally; and (ii) send the data sample (401, 701) and/or one or more of the any intermediate outputs (406) to a remote location (407, 702) for input to a second model (408, 705) stored remotely to form the predicted output (410).

### CROSS-REFERENCE TO RELATED APPLICATIONS

This application is a continuation of International Application No. PCT/EP2022/057740, filed on Mar. 24, 2022, the disclosure of which is hereby incorporated by reference in its entirety.

### FIELD OF THE INVENTION

This disclosure relates to the processing of data, for example during inference to form a predicted output, that can be performed locally at a device or jointly at the device and at a remote location, such as a cloud server.

### BACKGROUND

There have recently been several breakthroughs in the field of Machine Learning (ML) in well-known tasks and applications such as image classification, analytics, face/object recognition, natural language processing and regression type predictions, using the Deep Learning (DL) paradigm. As a result, many technology companies have decided to deploy DL models and offer relevant services to their users for a variety of ML tasks. However, given that the execution of these models is energy and time consuming, standard approaches for such services were based on cloud computing. In particular, when a data point (or sample) arrives and a device, such as a laptop computer, has to perform an inference task, the sample is sent to the cloud where it is processed by a large DL model. The output is then returned back to the device. In this context, ML inference is defined as the process of running the data into an ML algorithm or model to calculate an output, such as a numerical score, a numerical value for regression tasks, or a class when dealing with classification problems.

The current standard practice in the industry is therefore to transmit the data sample towards the cloud, where powerful servers take care of the forward pass. This approach has an obvious upside: arbitrarily large DL models can be used to run the forward pass operation, which is otherwise not feasible for energy-constrained devices running on batteries. On the other hand, inference takes longer and according to recent studies, using too many layers may be potentially harmful in terms of prediction accuracy.

Since users are utilizing their mobile devices increasingly often, there is additionally an emerging need to perform ML tasks on devices that reside at the edge of the network and that are wirelessly connected to the cloud. As a result, hardware manufacturers have started integrating DL models on-device in order to speed-up ML inference and/or to avoid using the wireless medium for every inference request, so that inference takes place with extremely low delay. It is evident though that deploying large models, such as AlexNet or ResNet, on mobile devices would be impractical for energy consumption reasons. Due to the latter, this approach is limited to smaller models that may suffer from lower prediction accuracy.

For mobile computing, this gives rise to an important question: “Where should the model execution take place-on cloud, on device, or a combination of both?”. The question is highly non-trivial, as it presents a clear trade-off: local inference (i.e., on device) accounts for low delay in the order of milliseconds, while remote execution (on cloud) offers the capability for significantly larger DL models, at the cost of much higher response delay.

To this end, the flexible setup of distributed deep neural networks (DDNNs) for inference has recently emerged as a promising approach. An example of such an approach is described in S. Teerapittayanon, B. McDanel, H. T. Kung, “Distributed Deep Neural Networks over the Cloud, the Edge and End Devices,” in IEEE ICDCS, 2017, and a representative view is depicted in FIG. 1. A deep neural network (DNN) of N layers is partitioned at layer level. N_{edge} of these layers are placed at the edge device 101, while the remaining N_{cloud}=N−N_{edge} layers are located at the cloud 102. The system is equipped with one or more so-called “local exits”. A local exit is the output prediction of some layers at the edge side of the DNN, for example a numerical value for regression or a class for classification.

During the inference phase, with the arrival of every data sample x, 103, ideally a DDNN mechanism should be able to decide optimally whether the prediction should be offloaded to the cloud by using the full DNN or if the local hardware is enough. If the local exit is selected, only the local model is executed and the final inference result is the local prediction. In this case, no bits are transmitted through the wireless channel to the cloud server, and there is no knowledge of what could have happened if all DNN layers were used. Otherwise, the sample is first forward passed through the local layers, then the output of one of these layers is sent to the cloud server through the wireless channel and used as input for the remaining layers at the cloud. The inference of the full DNN is returned to the device through the wireless channel.

Despite the flexibility and the practical interest in the DDNN setup, there are two significant challenges that need to be addressed. The first challenge lies in how to train a DNN with more than one exit, and more importantly how to train it in order to output useful and relevant predictions for all its exits. Centralized or distributed training can be used for this purpose, depending on the problem's needs, as the edge and cloud entities are usually located geographically far apart.

The second key concern of a DDNN is how to take the offloading decision. In principle, the device receives a sample and has at its disposal the local layers (and all intermediate outputs) and an implemented logic that decides which exit to be used. Based on this information, which part of the data and what type of algorithm should output this decision? A common way to proceed is to use the confidence of the local exit prediction. However, such an approach mostly makes sense for classification tasks, where the entropy of the exit (probability mass function over the classes) can be used as a quantifier of the confidence.

Deciding based on the confidence has three major weaknesses. Firstly, it is restricted to classification problems and cannot generalize to other tasks such as regression (for example, time series prediction, analytics etc.), which are equally important when it comes to distributed inference with DNNs. Also, the local exit confidence is not necessarily a relevant proxy for the quality of the exit; the local exit can be correct and uncertain. Furthermore, useful data are not exploited, such as the input sample x, which may reveal interesting structural properties for the decision.

Another approach, as described in Y. Kang, J. Hauswald, C. Gao, A. Rovinski, T. Mudge, J. Mars, and L. Tang, “Neurosurgeon: Collaborative intelligence between the cloud and mobile edge,” in ASPLOS, 2017 showed the benefits of partitioning a DNN at layer level. In this approach, a DNN is partitioned over the device and the cloud, and the sample is forward passed through all available layers every time. By performing an exhaustive search over (a) multiple choices of “break-point” layers (how many layers at the device, and how many at the cloud) and (b) various wireless protocols, the aim of this study was to provide performance measurements for energy consumption and latency. The architecture is depicted in FIG. 2, where each of the blocks F₀, F₁, F₂, shown at 201, 202 and 203 respectively, are DL models (or functions) that consist of one or more DNN layers. The blocks 201 and 202 are located at the edge device 204 and the block 203 is located at the cloud 205. The sample 206 is forward passed through all available layers every time.

An obvious drawback of this work is that it lacks flexibility, as all samples are by default sent to the cloud, which can lead to high delays and is not necessarily beneficial, since for some samples fewer layers could lead to better accuracy.

In a more recent work (see S. Tecrapittayanon, B. McDanel, H. T. Kung, “Distributed Deep Neural Networks over the Cloud, the Edge and End Devices,” in IEEE ICDCS, 2017), as depicted in FIG. 3, a percentage of samples can exit at the device 301 without being sent to the cloud 302. To do so, the concept of decision mechanism and local exit were introduced. The decision mechanism, schematically illustrated within box 303, determines if the sample will be resolved locally (on device), or if additional processing should be applied. Notably, this work targets image classification problems only. The algorithm used to indicate where inference will take place is based on comparing the entropy of the local prediction with some pre-decided threshold.

The sample x, 304, is forward-passed through F₀ 305 and edge layer output z is produced. Edge layer output z is fed to the function F₁ 306 which outputs the local prediction y⁰. The entropy of y⁰ is calculated. If the entropy is high, z is sent to the cloud 302 where it passes through the rest of the layers F₂ 307. Otherwise, the local prediction y⁰ is returned, thus avoiding the transmission to the cloud.

A main limitation of this work is that the controller is based on a heuristic choice, as in principle the entropy/uncertainty of an output is not necessarily a good proxy to how accurate the output actually is. Furthermore, the entropy of an output is a natural way to quantify uncertainty in probability mass functions over a discrete support set (e.g., classify among M different classes) and does not generalize to other tasks such as regression (for example, time series prediction).

It is desirable to develop a method which overcomes such problems.

### SUMMARY

According to one aspect, there is provided a device for processing a data sample to form a predicted output, the device being configured to: receive the data sample; input the data sample and/or one or more of any intermediate outputs derived from the data sample to a learnable control function; and in dependence on an output of the learnable control function, perform one of the following: (i) process the data sample to form the predicted output using a first model stored locally at the device; and (ii) send the data sample and/or one or more of the any intermediate outputs derived from the data sample to a remote location for input to a second model stored at the remote location to form the predicted output.

The controller is designed as a learnable function that can exploit the inherent semantic characteristics of the data samples. The device can decide whether to execute locally on-device or jointly locally and remotely (for example, at a cloud server) in dependence on one or more among the input sample itself and any intermediate outputs of the first model and not on a final output of the first model. This may result in reduced energy consumption, as the approach does not rely on local prediction confidence. The local predicted output is only formed if the controller dictates it and is not generated if the output of the controller indicates that the predicted output should be formed at the remote location. This may also result in faster and more accurate inference, as the controller can decide whether the predicted output will have higher accuracy if it is formed at the remote location.

If the output of the learnable control function exceeds a threshold, the device may be configured to process the data sample to form the predicted output using the first model stored locally at the device. The threshold may be a predetermined threshold. This may be a convenient way of determining whether to process the data sample locally to form the predicted output.

If the output of the learnable control function does not exceed a threshold, the device may be configured to send the data sample and/or one or more of the any intermediate outputs derived from the data sample to the remote location for input to the second model stored at the remote location to form the predicted output. The threshold may be a predetermined threshold. This may be a convenient way of determining whether to form the predicted output using the second model stored remotely.

The device may be configured to store and implement the first model. The any intermediate outputs derived from the input sample may be one or more intermediate outputs (i.e. not the final output) of the first model. There may be multiple intermediate outputs of the first model. The intermediate output(s) input to the learnable control function may be one or more different intermediate output(s) to the intermediate output(s) sent to the remote location. The first model may comprise multiple parts. One intermediate output may comprise an output of a first part of the multiple parts. Other intermediate outputs may comprise respective outputs of other parts of the first model.

The first part of the first model may be configured to encode the data sample. This may allow the data sample to be encoded locally while the data sample is concurrently input to the learnable control function. The encoded data sample can then be sent to the cloud. This may improve the efficiency of the process.

In some embodiments, the device may be configured to input the data sample to the learnable control function, and, in dependence on the output of the learnable control function, send the data sample to the remote location for input to the second model to form the predicted output.

As discussed above, the intermediate output(s) input to the learnable control function may be different intermediate output(s) to the intermediate output(s) sent to the remote location. For example, where the device is configured to input an intermediate output of the first part of the first model to the learnable control function, the device may be configured to send the output of another intermediate (i.e. not final) part of the first model to the remote location in dependence on the output of the learnable control function. Alternatively, where the first intermediate output comprises an output of another intermediate part of the first model, the device may be configured to send the output of the first part of the first model to the remote location in dependence on the output of the learnable control function. In other examples, the intermediate output(s) input to the learnable control function may be the same intermediate output(s) as the intermediate output(s) sent to the remote location.

The first model may have lower computational requirements and/or a lower storage size requirement than the second model. For example, the first model may comprise fewer convolutional layers than the second model. This may allow on-device predictions to be formed quickly and efficiently.

The learnable control function may be configured to form the output based on features extracted from the data sample. For example, if the data sample is an image, the learnable control function may form the output based on features extracted from the image.

The learnable control function may be configured to be optimized in dependence on a series of data samples and their respective true outputs. This may, for example, allow the control function to be trained to learn which features of an input image should be used to reliably determine whether the inference should be performed at the device or at the remote location. This may also allow the control function to be trained in a principled manner based on gradient descent steps and not on heuristic threshold-based approaches.

The first model and the second model may be learnable models. Each of the first and second models may be configured to be optimized in dependence on the series of data samples and their respective true outputs. The first and second models may be trained with the control function, either jointly or sequentially. This may allow the system as a whole to be optimized, which may result in more accurate predictions.

The remote location may be a cloud server. This may allow large and powerful second models to be stored at the remote location that can be used to form the predicted output when necessary. This may allow for the formation of more accurate predictions.

The learnable control function may be a neural network comprising one or more convolutional layers. Different DL building blocks may be used, such as DNNs, CNNs and FC layers, depending on the application. This may allow for a flexible approach that can be tailored for the application.

The input sample may be an image or a time series of data. This may allow the device to be used for various image classification, object/facial recognition applications and in multivariate time series prediction tasks.

The device may be a network node or an edge device in a communications network. This may allow the approach to be implemented for a variety of network configurations.

According to a second aspect, there is provided a method for processing a data sample to form a predicted output, the method comprising: receiving the data sample; inputting the data sample and/or one or more of any intermediate outputs derived from the data sample to a learnable control function; and in dependence on an output of the learnable control function, performing one of the following: (i) processing the data sample to form the predicted output using a first model stored locally at the device; and (ii) sending the data sample and/or one or more of the any intermediate outputs derived from the data sample to a remote location for input to a second model stored at the remote location to form the predicted output.

In this method, the controller is designed as a learnable function that can exploit the inherent semantic characteristics of the data samples. The method decides whether to execute locally on-device or jointly locally and remotely (for example, at a cloud server) in dependence on one or more among the input sample itself and any intermediate outputs of the first model and not on a final output of the first model. This may result in reduced energy consumption, as the approach does not rely on local prediction confidence.

According to a further aspect, there is provided a computer-readable storage medium having stored thereon computer-readable instructions that, when executed at a computer system, cause the computer system to perform the method set out above. The computer system may comprise one or more processors. The computer-readable storage medium may be a non-transitory computer-readable storage medium.

### BRIEF DESCRIPTION OF THE FIGURES

The present disclosure will now be described by way of example with reference to the accompanying drawings.

In the drawings:

FIG. 1 schematically illustrates a basic prior art setup for distributed inference with a device at the edge with DNN layers and a local exit, and potential signalling of intermediate layer outputs towards the cloud server.

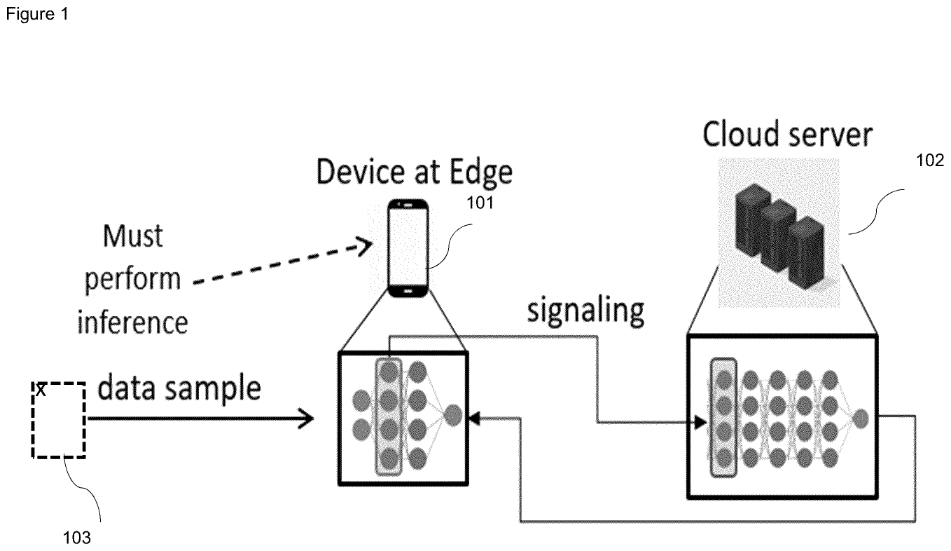

FIG. 2 schematically illustrates a prior art DNN partitioned over an edge device and a cloud server.

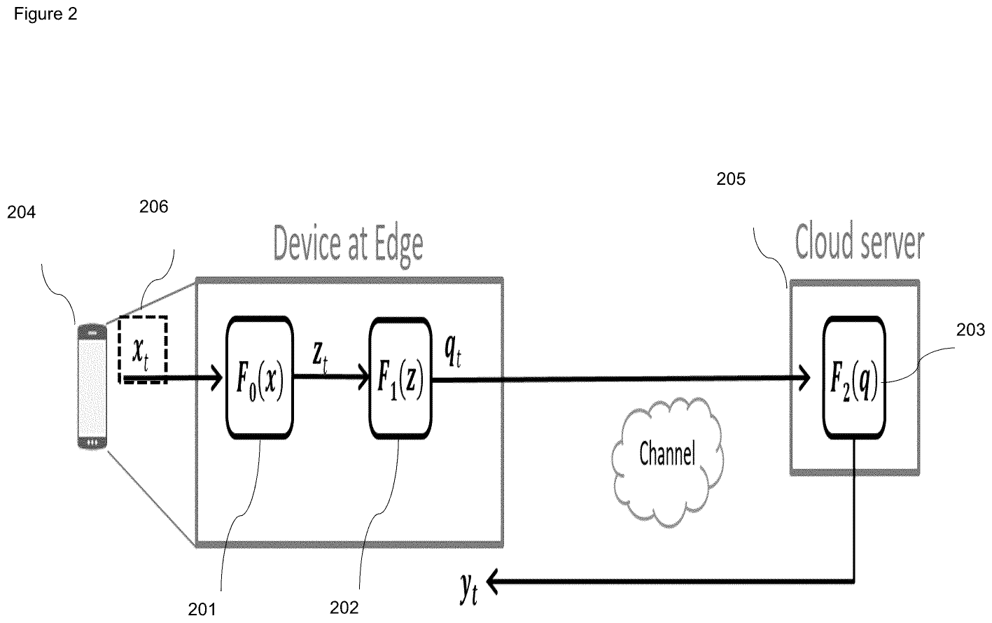

FIG. 3 schematically illustrates a prior art DDNN with early (local) exit and entropy-based controller mechanism.

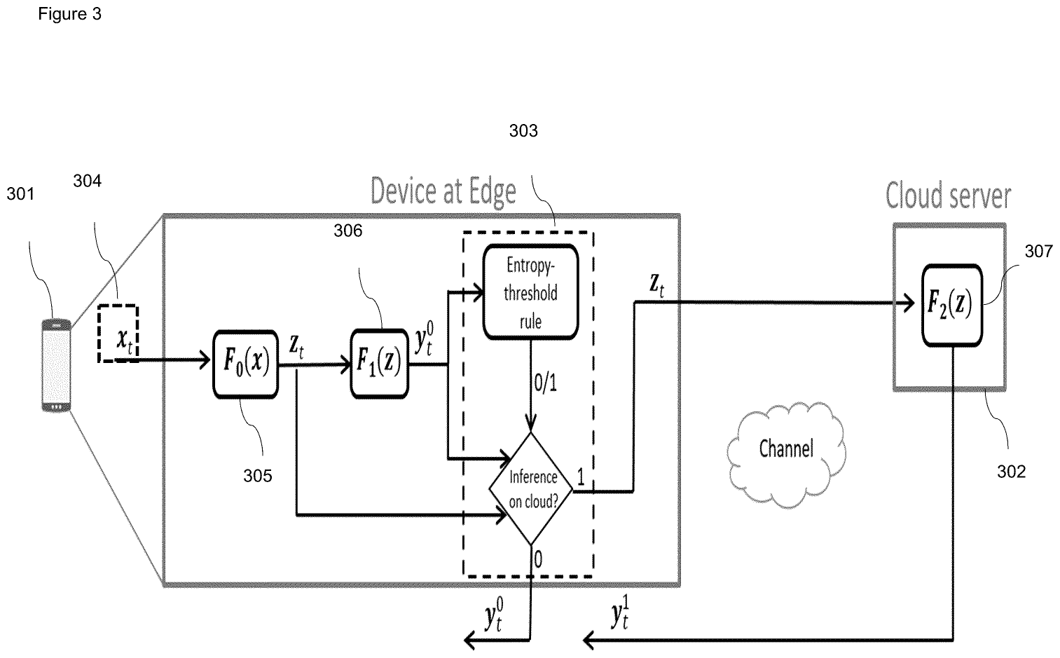

FIG. 4 schematically illustrates an exemplary architecture with the controller implemented as a learnable function.

FIG. 5 schematically illustrates a flowchart showing decisions, actions and signal flow.

FIG. 6 schematically illustrates an example of the joint training of all sub-models involved.

FIG. 7 schematically illustrates an exemplary embodiment setup.

FIG. 8 shows an example of a method for forming a predicted output in accordance with embodiments of the present invention.

FIGS. 9 (a)-9(c) show histograms of p over the full training set for different training epochs. FIG. 9 (a) shows values for epoch 1, FIG. 9(b) for epoch 3 and FIG. 9(c) for epoch 70.

FIG. 10 shows an example of results, comparing a time series signal with DDNN predictions.

### DETAILED DESCRIPTION

In embodiments of the present invention, the decision/controller mechanism is a learnable function that can leverage machine learning techniques and exploit the semantic properties of the input sample to decide whether the input sample is to be processed locally at a device or whether it is to be at least partially processed at a remote location, such as a cloud server.

The device may be, for example, a network node or an edge device in a communications network. In one implementation, the device may be a base station. In other implementations, the device may be a mobile phone, tablet, laptop or PC. The device and the remote location are preferably connected via a network. The remote location may be a cloud server or some other remote server or device.

The device may comprise a processor and a memory. The memory stores in a non-transient way code that is executable by the processor to implement the device in the manner described herein. The device may also comprise a transceiver for transmitting and receiving data. The network may be a wireless network or a wired network.

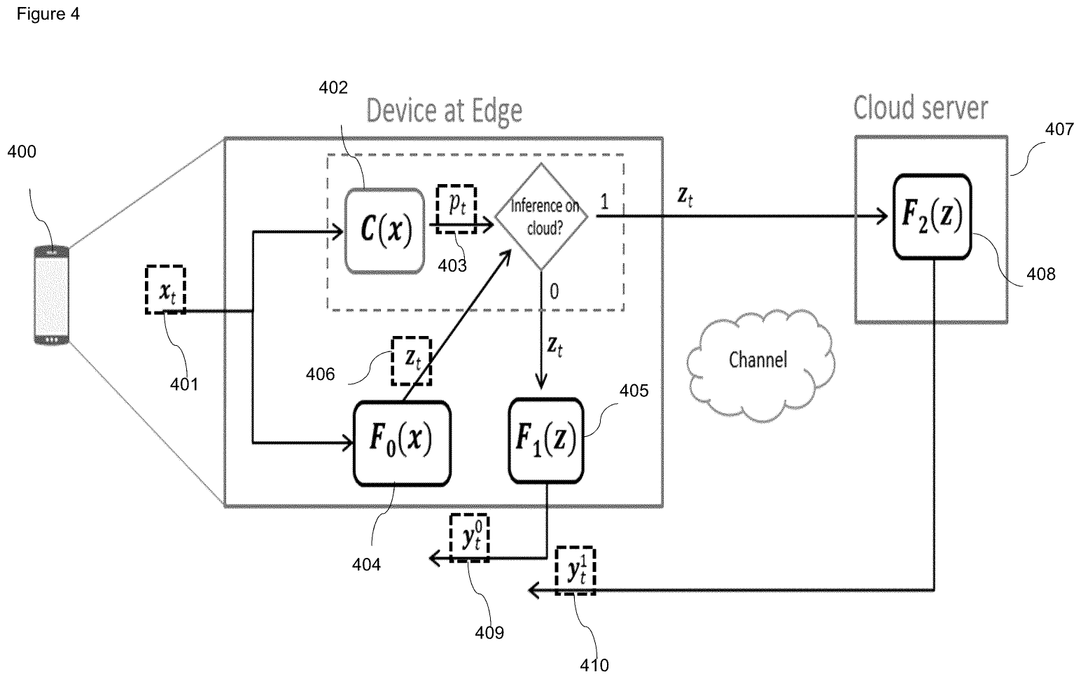

As schematically illustrated in the example of FIG. 4, the device 400 is configured to receive an input sample xₜ, 401.

In this example, edge device 400 is a mobile phone. From the input sample 401, it is desired to form a predicted output. This may be an output relating to applications such as image classification, analytics, face/object recognition, natural language processing and regression type predictions. The input sample may, for example, be an image, a time series of data or some other data sample. For example, in one specific classification application, the predicted output may be a prediction indicating whether an input image represents an image of a dog, or does not.

The device 400 implements a decision controller module that controls which samples will be resolved locally, and which will be resolved remotely. In the preferred implementation, samples resolved remotely to form the predicted output will be processed using a full DNN forward-pass of a larger model than the model used for the local processing.

As shown in FIG. 4, the input sample xₜ 401 is forward-passed through the controller function C (x) 402 to form an output 403. The controller function 402 is preferably stored locally at the device 400, and the device is configured to implement the controller function. The output 403 of the controller function can be considered to be a decision signal. In this example, the output of the learnable control function is edge controller output p.

C(x) is a learnable control function. The learnable control function 402 may be configured to form the output 403 based on features extracted from the input sample 401. For example, based on features in or extracted from an input image. The learnable control function may be configured to be optimized during training in dependence on a series of data samples and their respective true outputs, as will be described in more detail later. The learnable control function may be a neural network comprising one or more convolutional layers.

The output 403 of the learnable control function dictates whether inference will take place locally or remotely, as will be described in more detail below.

A first model is stored locally at the device. The device is configured to implement the first model. In this example, the first model comprises multiple functions F₀(x) and F₁(z), shown at 404 and 405 respectively. In this example, the input to the first part of the model 404 is the same as the input to the separate learnable control function 402 (i.e. the input is data sample xₜ). The output of the first part of the first model 404 is zₜ, shown at 406. The first part of the first model may be configured to encode the data sample. zₜ may therefore be an encoded version of the input data sample xₜ.

In other embodiments, the input to the learnable control function may be an intermediate output derived from the data sample, such as zₜ (the output of the first part of the first model 404), or the output of another intermediate part (i.e. not the final output) of the first model, in cases where the first model comprises more than two parts. In some embodiments, the input to the learnable control function may be multiple intermediate outputs of the first model. The input to the learnable control function does not comprise a final output of the first model. In some embodiments, both the data sample and any intermediate output of the first model (or more than one intermediate output of the first model, where the first model comprises more than two parts) may be input to the learnable control function.

A second model is stored at a location remote to the device. For example, at a cloud server, shown at 407 in FIG. 4. In this example, the second model comprises function F₂(z), 408. The cloud server 407 is configured to implement the second model.

The first model 404, 405 may have lower computational requirements and/or a lower storage size requirement than the second model 408. For example, the first model may comprise fewer convolutional layers than the second model.

Optionally, xₜ may be input to the first part of the first model 404 simultaneously to xₜ being forward-passed through the controller function C(x) 402.

As shown in the example of FIG. 4, input sample xₜ is forward-passed through F₀(x) and edge layer output zₜ is produced. zₜ is an intermediate output of the first model. zₜ can be stored at the device for potential transmission to the cloud or for input to the second part of the first model F₁(z).

In the example shown in FIG. 4, if the output of the learnable control function p indicates that the inference should be performed locally at the device, only then is intermediate output zₜ fed to the second part of the first model, F₁(z). In this case, the local prediction yₜ⁰, 409, is formed and used as the predicted output.

Otherwise zₜ, the output of the first part of the first model, can be forwarded to the cloud for additional processing by the second model F₂(z), 408. In this case, the predicted output is the one from the cloud, that is yₜ¹, 410.

Alternatively, xₜ may be sent to the cloud server 406 directly in response to the learnable control function 402 indicating that the input sample should be processed remotely. However, encoding the input sample 401 at the device 400 by inputting it to the first part 404 of the first model may reduce processing time if this is done concurrently with the input sample 401 being put through the learnable control function 402.

In the example described with reference to FIG. 4, the device is configured to input the data sample xₜ to the learnable control function. In other embodiments where the device is configured to input an intermediate output derived from the data sample to the learnable control function, if the output of the learnable control function indicates that the inference should be performed using the second model at the remote location, the device may be configured to send this intermediate output and/or a different intermediate output to the remote location for input to the second model. Optionally, the data sample may be sent as well. For example, where the first model comprises more than two parts, and where the intermediate output that is input to the learnable control function comprises an output of a first part of the first model, the device may be configured to send the output of another intermediate part of the first model to the remote location in dependence on the output of the learnable control function. Alternatively, where the intermediate output that is input to the learnable control function comprises an output of another intermediate part of the first model, the device may be configured to send the output of the first part of the first model to the remote location in dependence on the output of the learnable control function.

The learnable control function can therefore receive one or more of (i) the input sample and (ii) at least one of any intermediate outputs of the first model, such as zₜ (but not the final output of the first model) as input and output a decision signal.

In dependence on the decision signal, the device is configured to (i) process the input sample to form the predicted output by inputting it to the first model stored locally at the device, or (ii) send the input sample and/or one or more of any intermediate outputs derived from the input sample (such as zₜ), but not the final output of the first model, to the cloud for processing by the second model to form the predicted output. The output of the learnable control function (i.e. the decision signal) is not based on the entropy or uncertainty of a final output of the first model.

In one example, if the output 403 of the learnable control function 402 (p in the example shown in FIG. 4) exceeds a threshold, the device is configured to process the data sample to form the predicted output using the first model stored locally at the device. If the output of the learnable control function does not exceed a threshold, the device is configured to send one or more of the data sample and any intermediate outputs derived from the data sample to the remote location for input to the second model stored at the remote location to form the predicted output.

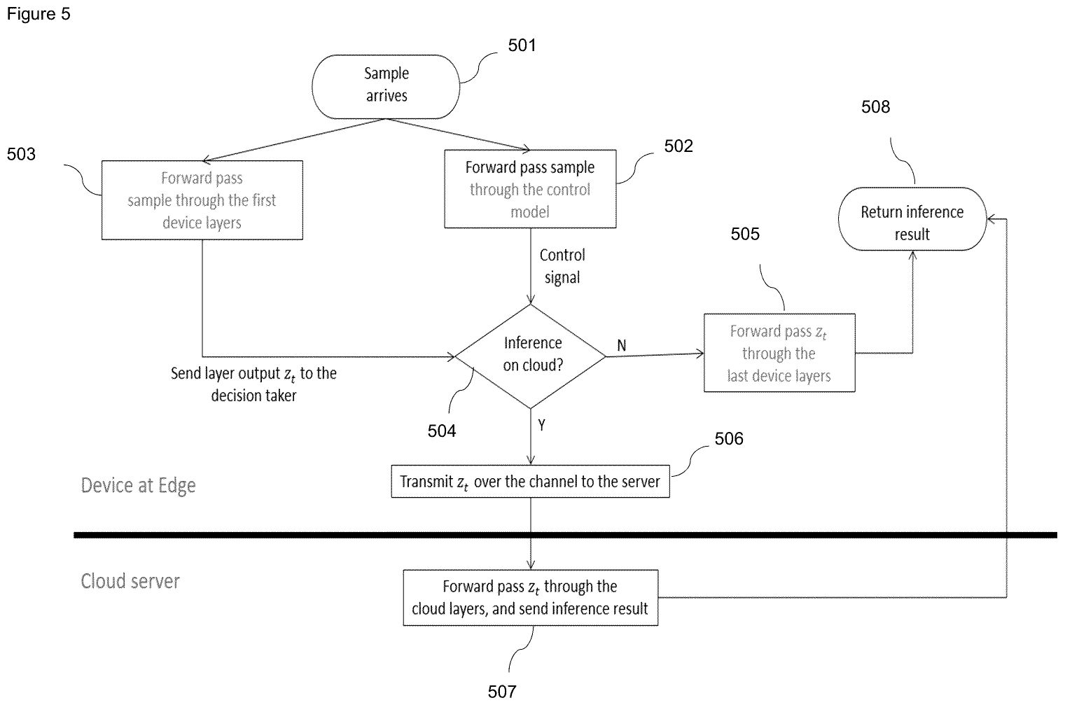

A flowchart summarizing one example of the operation of the system is depicted in FIG. 5.

At step 501, the input sample arrives at the device. At step 502, the device performs a forward pass on the input sample through the learnable control function. The learnable control function outputs a control/decision signal. In this example, at step 503 the device simultaneously performs a forward pass on the input sample using the first layers of the model stored locally at the device (F₀(x), 404, in FIG. 4).

At 504, based on the output of the learnable control function (and not on the output of the first part of the first model) the device decides whether the inference (i.e. the formation of the predicted output) should be performed at the device or at the remote location.

If, based on the output of the control function, the device decides that inference should be performed locally at the device, the device performs a forward pass of zₜ using the last device layers (i.e. the remaining part(s) of the first model 405), as shown at 505, and the inference result is formed at the device.

If, based on the output of the control function, the device decides that inference should be performed remotely at the cloud server, the device sends zₜ to the cloud server, as shown at 506, and the cloud server implements the second model to perform a forward pass on zₜ, as shown at 507. The inference result is formed at the cloud. The inference result can then be returned to the device, as shown at 508.

Therefore, in dependence on an output of the learnable control function, the device is configured to process the data sample to form the predicted output using a first model stored locally at the device, or send one or more among the data sample and any intermediate outputs derived from the data sample (such as zₜ) to a remote location for input to a second model stored at the remote location to form the predicted output. The device does not send the final output of the first model to the remote location for further processing.

The learnable control function C(x) is a function that can be optimized using training data. For example, the control function can learn which features of an image should be used to reliably determine whether the inference should be performed at the device or at the cloud server. Furthermore, the first and second models may also be trainable.

Each of the first and second models may be configured to be optimized in dependence on a series of training data samples and their respective true outputs.

An example of the training process for the learnable functions will now be described.

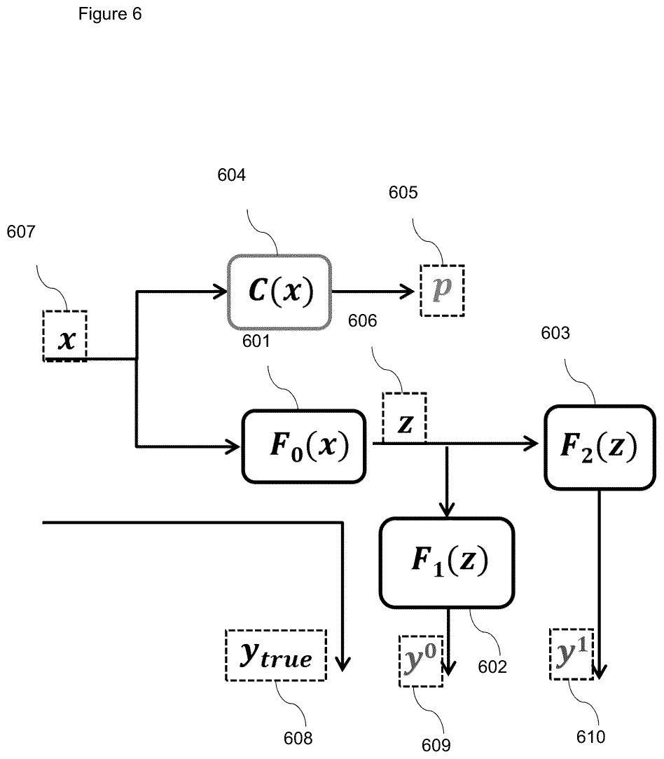

The goal is to devise a training (optimization) procedure based on the desired loss function and the variables that have an effect on it. A signal flow diagram that provides an abstract level description of the DNN training is shown in FIG. 6, which schematically illustrates joint training of all sub-models involved.

In these examples, the first model comprises two parts F₀, F₁ shown at 601, 602 respectively and the second model comprises one part F₂, shown at 603. In other embodiments, the first model may comprise at least two parts and the second model may comprise multiple parts. F₀, F₁, F₂, shown at 601, 602, 603 respectively, are DNN models of appropriate size. In this example, the controller function C 604 is also a DNN itself. The output of the controller function is p shown at 605 and the output of the first part of the first model, z, is shown at 606.

The training data sets each comprise a data sample x, shown at 607, and its respective true output yₜᵣᵤₑ, shown at 608.

The local predicted output, y⁰, is shown at 609 and the remote predicted output, y¹, at 610.

In the following, two ways of performing the DDNN training are presented as examples. Firstly, a joint method (all models together), and secondly a sequential method (first the F₀, F₁, F₂ models and then the learnable controller).

A way to bind all four sub-models in this example is to consider a technique called “joint training”, where multiple exits are included in a single loss function. If there was no controller, to indicate the importance of each exit one could consider fixed scalar weights w₀ and w₁ to show the importance of the local and the remote exit respectively, by using the following loss function during backpropagation:

$$L ( {y}_{true} , {y}^{0} , {y}^{1} ) = {w}_{0} L ( {y}_{true} , {y}^{0} ) + {w}_{1} L ( {y}_{true} , {y}^{1} )$$

where L(yₜᵣᵤₑ,yⁱ) is a loss function that depends on the ML task, e.g., Mean Squared Error (MSE) for regression, or Categorical Cross Entropy (CCE) for classification tasks. This allows the controller to probabilistically choose which exit will be more important by relaxing the decision signal p and by considering it as a probability value ∈ [0,1].

$$L ( {y}_{true} , {y}^{0} , {y}^{1} , p ) = ( 1 - p ) L ( {y}_{true} , {y}^{0} ) + pL ( {y}_{true} , {y}^{1} )$$

Using the above-depicted loss function, the DNN parameters of all models, i.e., F₀, F₁, F₂ and C, are all updated jointly during every backpropagation step.

The above-described procedure trains all DNN models F₀, F₁, F₂ and C that produce the three output signals p, y⁰, y¹ of the system jointly. However, this is a process that could also be done in separate steps in sequential training. In particular, one could break the training loop into two steps as follows:

Consider some importance for the output of the two exits, e.g., equal importance with w₀=w₁=1 that leads to L(yₜᵣᵤₑ,y⁰,y¹)=L(yₜᵣᵤₑ,y⁰)+L(yₜᵣᵤₑ,y¹). This step will train all sub-models that are required to perform the inference.

Moreover, once F₀, F₁, F₂ are all trained, they are considered as known/fixed models; one can exploit by forward-passing all available samples x, and by measuring the losses L₀(x)≡L(yₜᵣᵤₑ,y⁰) and L₁(x)≡L(yₜᵣᵤₑ,y¹).

Thus, in this example, for every sample there are two scalar numbers revealing the losses experienced in the two exits. These two values can be used in order to view the training of the controller:

$$L ( p ; x ) = ( 1 - p ) {L}_{0} + {pL}_{1}$$

and perform gradient steps only for the DNN model parameters of C over the above loss function.

It is, however, also possible to view the problem of choosing the lowest cost exit explicitly as a classification problem. Assuming known transmission costs (device to cloud plus cloud to device) T, the following can be performed: for every x, if L₁(x)+T<L₀(x): the label of x is “1”, else it is “0”. The training loop can be run as a classification (supervised learning) problem with known labels.

Note here that the inequality L₁(x)+T<L₀(x) reads: for a sample x, if the cost of remote inference together with the transmission costs T is smaller than the cost of local inference, then the system must consider to resolve this sample remotely.

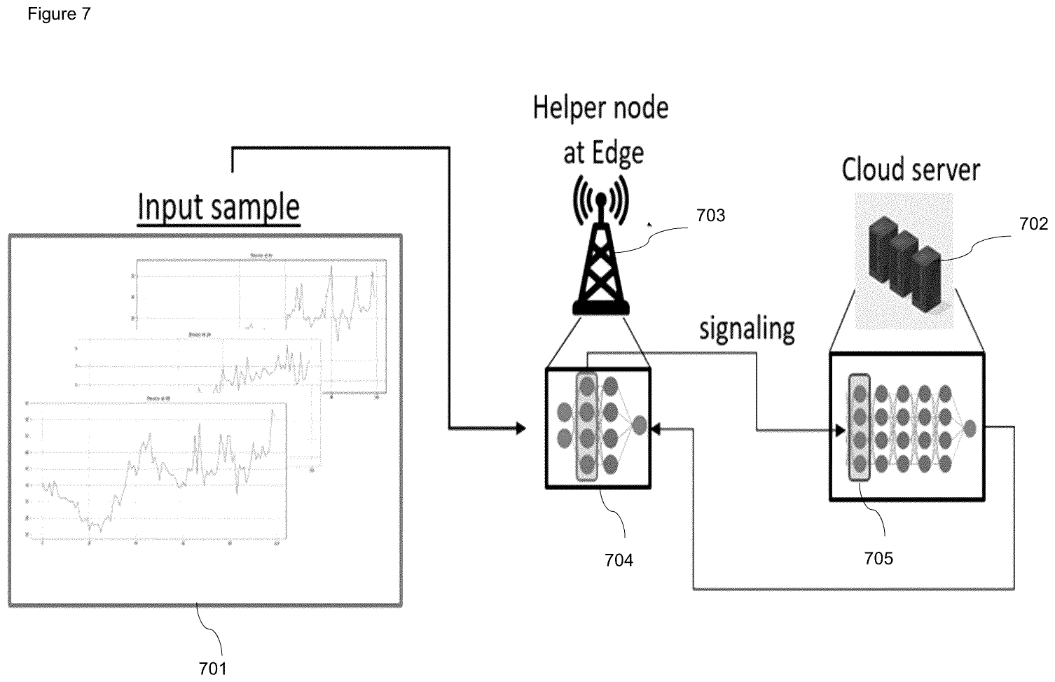

FIG. 7 schematically illustrates a further exemplary embodiment of a system during the inference phase. In this example, the input sample 701 comprises a stream of traffic signals from M base stations (BSs) that arrives at some cloud server 702. In this example, the mission of the cloud server 702 is to perform some analytics task on this set of measurements. For example, the cloud server may perform traffic prediction for the next (or more) time instance(s) for all BSs. In this setup, this server can be mapped to the cloud server node. However, given the emerging need of future wireless networks for more accurate and faster inference, a helper node 703 can be employed that acts as the local device.

Thus, in this embodiment, the local inference is performed at the helper node 703 and the remote inference for the additional layers at the cloud server 702.

In summary, the system operates as follows. A time series of the N past samples (from t−N, . . . , t−1) of the M BSs are fed to the helper node 703, as shown at 701. Given these measurements, the helper node 703 may predict the traffic at time t for every BS involved, for example to be used for resource provision.

The helper node 703 is equipped with a controller that receives the input data 701 and decides, at every time t, if it is better to carry out the prediction locally (using only the device layers) or forward the output of the intermediate layers z to the cloud server. The controller implements a learnable control function, as described previously.

In one implementation of the arrangement shown in FIG. 7, for a realistic and challenging environment, real data from the Milan Traffic Dataset was used to train the controller function and the first and second models. M=49 BSs were considered. For prediction purposes, N=6 past time instances were utilised. The input sample is therefore an array of size M×N, and the desired output is an array of size M (one traffic prediction for each BS).

The mobile networking community has indicated that it is beneficial to use Convolutional Neural Networks (CNNs) for traffic prediction related tasks, especially when multiple BSs (that are spatially or temporally correlated) are involved.

To this end, the helper node may advantageously implement a CNN as F₀ to encode the input sample (to produce z) and one or more fully connected (FC) layers as F₁ to decode z and return local exit y⁰. The first model, comprising F₀ and F₁, is collectively shown at 704 in FIG. 7.

At the cloud server node 702, a CNN and/or one or more FC layers may be placed as F₂, shown at 705. This function F₂ receives z and outputs y¹ (the remotely predicted output).

In this example, the learnable function at the controller is represented by one or more FC layers that receive the data sample x as input and output a decision signal. In dependence on the decision signal, the helper node processes the data sample to form the predicted output using a first model stored locally at the device, or sends the intermediate output z derived from the data sample to the cloud server 702 for input to the second model stored at the cloud server to form the predicted output.

The above architecture is suitable for use in multivariate time series prediction tasks. Different DL building blocks may be used (instead of CNNs and FC layers) depending on the application.

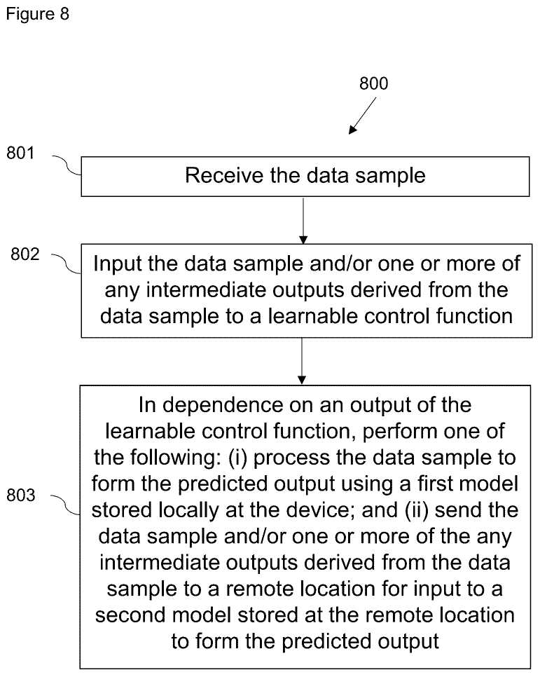

FIG. 8 shows a flowchart for an example of a method for processing a data sample to form a predicted output in accordance with embodiments of the present invention. At step 801, the method comprises receiving the data sample. At step 802, the method comprises inputting the data sample and/or one or more of any intermediate outputs derived from the data sample to a learnable control function. At step 803, the method comprises, in dependence on an output of the learnable control function, performing one of the following: (i) processing the data sample to form the predicted output using a first model stored locally at the device; and (ii) sending the data sample and/or one or more of the any intermediate outputs derived from the data sample to a remote location for input to a second model stored at the remote location to form the predicted output.

The present approach is different from confidence-based approaches. Instead, the controller is designed as a learnable function that can exploit the inherent semantic characteristics of the input samples. The device can decide whether to execute locally on-device or additionally remotely (for example, at a server) in dependence on the input sample itself and/or any intermediate output(s) of the first model and not on an final output of the first model implemented by the device.

The suggested architecture and training have several advantages compared to earlier approaches, as discussed below.

The method described herein may result in reduced energy consumption. The function F₁ is not executed for every input sample, as in the prior DDNN approach. Known DDNN architectures make use of local prediction confidence. Therefore, these approaches must generate a predicted output for all incoming samples. However, in embodiments of the present invention, the local predicted output is only generated if the controller dictates it and is not generated if the output of the controller indicates that the predicted output should be generated at the remote location.

The method is application independent. Designing the controller C(•) as a learnable function allows for the generation of decisions independently of the task; it is no longer necessary to find ways to quantify the confidence of the exits. The approach described herein presents a more general way of deciding. In the literature or industry, there is no DDNN architecture that is application (task) independent. The controller described herein is not based on the uncertainty/confidence of the local prediction (which needs special care for different ML tasks), but is rather built as a learnable function in a higher abstraction level.

As discussed previously, the controller may, without requiring heavy modification, also use further intermediate outputs of the local DNN (i.e. the first model stored locally at the device) as its input. For example, an intermediate output of F₀. The earlier state of the art only considers the local exit data and discards rich information from the input data sample (and potentially intermediate outputs).

The controller C(•) performance is based on principled gradient descent steps, and not on heuristic threshold-based protocols.

Prior works considering a problem of “cloud offloading” use reduced information (only the local prediction y⁰), focusing on the confidence (entropy) of the output (a proxy metric for the quality of the exit), which is in general arbitrary.

To that end, the controller described herein can capitalize the semantic structure of the input sample and use an increased amount of information from the local layers. By casting a problem of “whether to offload to the cloud or not” as an ML problem itself, instead of using pre-defined heuristic rules, the loss function and the signal flow can be formulated such that the controller model has the true loss minimization as an explicit target.

For the results presented below, the models (inference model plus controller) were trained using the “sequential training” approach.

Having described the architecture of the system, a reasonable baseline is to consider a fully centralized DNN placed at the cloud server that has two CNNs, and three FC layers (therefore, same representation capabilities as the case where all samples are resolved at the cloud).

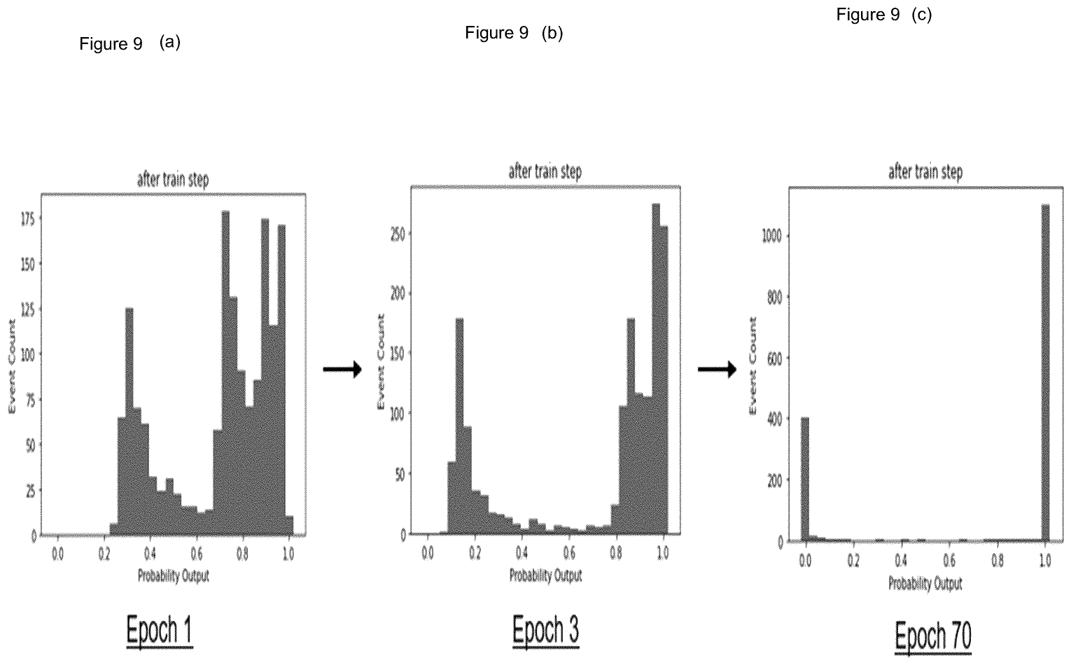

FIGS. 9 (a)-(c) show plotted histograms of the values of decision probability p (i.e., the probability to do more processing at the remote cloud exit). FIG. 9(a) shows the values for epoch 1, FIG. 9(b) for epoch 3 and FIG. 9(c) for epoch 70. These can be used to validate that the learnable controller performs the non-trivial task of distinguishing samples.

In every histogram, a full forward pass of the training data points was performed, and the values of p that were produced by the controller are reported. From these plots, it is evident that as more training steps are performed, the controller splits the samples with certainty (“polarized” histogram to 0 and 1 in epoch 70).

In particular, if the controller outputs a value close to 1.0, it chooses to use the full DNN (local plus remote). If the controller outputs a value close to 0.5, its decision is not so certain. Finally, if the controller outputs a value close to 0.0, it chooses to use the local exit with certainty.

In the following, the performance gains of the architecture described herein are quantified and compared to the baseline during the inference phase. The discussion and evaluation below will rely on two metrics: prediction cost in the mean squared error (MSE) sense; and percentage of samples resolved locally. Table 1 below depicts these two metrics for both schemes under consideration.

TABLE 1
Main performance comparison result

| | | Percentage of Local |
|---|---|---|
| | MSE Cost (normalized) | Predictions (%) |
| Approach described herein | 0.69 | 20.1 |
| Baseline Centralized DNN | 1.0 | 0.0 |

Table 1 indicates an improvement with respect to the baseline along two directions. First, the approach described herein is able to resolve ⅕ of the incoming traffic samples locally (and thus extremely fast without delays), and more importantly, the use of the intelligent controller at the edge side is responsible for a decrease of more than 30% in the MSE compared to a fully centralized DNN. The latter serves as evidence for the existence of structure on the input sample. The controller described herein is able to detect it and decide whether the said prediction would have higher accuracy with the use of a partial DNN locally at the device or full DNN at the cloud.

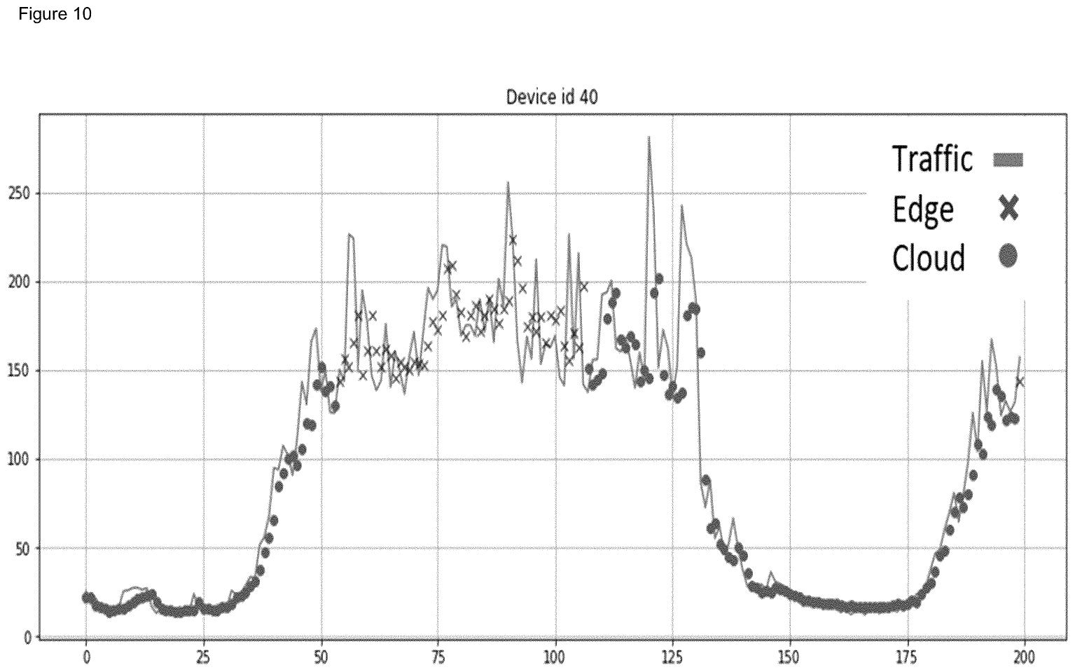

FIG. 10 shows a time series signal (continuous line) and DDNN predictions (edge/local: “x”, cloud/remote: “o”), i.e. the true BS traffic signal along with the predicted signal. For every time step, the controller decided whether the predicted signal would be the one exported by the device or by the cloud. The time series plot shows that the decisions made by the controller are reasonable, as in the depicted snapshot the predicted values chosen either from the edge or the cloud are close to the true signal and can thus be considered to be good predictions.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

What is claimed is:

1. A device (400, 703) for processing a data sample (401, 701) to form a predicted output (409, 410), the device (400, 703) being configured to:
receive (801) the data sample (401, 701);
input (802) the data sample (401, 701) and/or one or more of any intermediate outputs (406) derived from the data sample (401, 701) to a learnable control function (402); and
in dependence on an output (403) of the learnable control function (402), perform (803) one of the following:
(i) process the data sample (401, 701) to form the predicted output (409) using a first model (404, 405, 704) stored locally at the device (400, 703); and
(ii) send the data sample (401, 701) and/or one or more of any intermediate outputs (406) derived from the data sample (401) to a remote location (407, 702) for input to a second model (408, 705) stored at the remote location to form the predicted output (410).

2. The device (400) as claimed in claim 1, wherein, if the output (403) of the learnable control function (402) exceeds a threshold, the device is configured to process the data sample (401) to form the predicted output (409) using the first model (404, 405) stored locally at the device (400).

3. The device (400) as claimed in claim 1, wherein, if the output (403) of the learnable control function (402) does not exceed a threshold, the device (400) is configured to send the data sample (401) and/or one or more of the any intermediate outputs (406) derived from the data sample to the remote location (407) for input to the second model (408) stored at the remote location to form the predicted output (410).

4. The device (400) as claimed in claim 1, wherein the any intermediate outputs (406) derived from the data sample (401) are one or more intermediate outputs (406) of the first model (404, 405) stored at the device (400).

5. The device (400) as claimed in claim 4, wherein the first model comprises multiple parts (404,405) and one intermediate output (406) comprises an output of a first part (404) of the multiple parts.

6. The device (400) as claimed in claim 5, wherein the first part (404) is configured to encode the data sample (401).

7. The device (400) as claimed in claim 1, wherein the first model (404, 405) has lower computational requirements and/or a lower storage size requirement than the second model (408).

8. The device (400) as claimed in claim 1, wherein the first model (404, 405) comprises fewer convolutional layers than the second model (408).

9. The device (400) as claimed in claim 1, wherein the learnable control function (402) is configured to form the output (403) based on features extracted from the data sample (401).

10. The device (400) as claimed in claim 1, wherein the learnable control function (402, 604) is configured to be optimized in dependence on a series of data samples (607) and their respective true outputs (608).

11. The device (400) as claimed in claim 10, wherein the first model (404, 405, 601, 602) and the second model (408, 603) are learnable models, each of the first and second models being configured to be optimized in dependence on the series of data samples (607) and their respective true outputs (608).

12. The device (400, 703) as claimed in claim 1, wherein the remote location is a cloud server (407, 702).

13. The device (400) as claimed in claim 1, wherein the learnable control function (402) is a neural network comprising one or more convolutional layers.

14. The device (400, 703) as claimed in claim 1, wherein the input sample (401, 701) is an image or a time series of data.

15. The device (400, 703) as claimed in claim 1, wherein the device is a network node or an edge device in a communications network.

16. A method (800) for processing a data sample (401, 701) to form a predicted output (409, 410), the method comprising:
receiving (801) the data sample (401, 701);
inputting (802) the data sample (401, 701) and/or one or more of any intermediate outputs (406) derived from the data sample (401) to a learnable control function (402); and
in dependence on an output (403) of the learnable control function (402), performing (803) one of the following:
(i) processing the data sample (401, 701) to form the predicted output (409) using a first model (404, 405, 704) stored locally at the device (400, 703); and
(ii) sending the data sample (401, 701) and/or one or more of the any intermediate outputs (406) derived from the data sample (401) to a remote location (407, 702) for input to a second model (408, 705) stored at the remote location to form the predicted output (410).

17. A computer-readable storage medium having stored thereon computer-readable instructions that, when executed at a computer system, cause the computer system to perform:
receiving (801) a data sample (401, 701);
inputting (802) the data sample (401, 701) and/or one or more of any intermediate outputs (406) derived from the data sample (401) to a learnable control function (402); and
in dependence on an output (403) of the learnable control function (402), performing (803) one of the following:
(i) processing the data sample (401, 701) to form a predicted output (409) using a first model (404, 405, 704) stored locally at the device (400, 703); and
(ii) sending the data sample (401, 701) and/or one or more of the any intermediate outputs (406) derived from the data sample (401) to a remote location (407, 702) for input to a second model (408, 705) stored at the remote location to form the predicted output (410).
